(19) United States
(12) Patent Application Publication
(10) Pub. No.: US 2007/0150285 A1
(43) Pub. Date: Jun. 28, 2007

(54) Recorder adapted to interface with internet browser

(76) Inventor: Solomon Friedman, Brooklyn, NY (US)

Correspondence Address: Abelman Frayne & Schwab, 10th Floor, 666 Third Avenue, New York, NY, 10017-5621, US

(21) Appl. No.: 10/513,299

(22) PCT Filed: Feb. 9, 2001
(86) PCT No.: PCT/US01/04300

§ 371 Date: Jun. 28, 2006

Related U.S. Application Data
(60) Provisional application No. 60/181,431, filed on Feb. 10, 2000.

(51) Int. Cl. G10L 21/00

(52) U.S. Cl. 704/270.1

(57) ABSTRACT

A manually or voice-activated recorder interfaces with an Internet browser. A handheld recording device functions to record a vocal input signal including an analog representation of a website address. The analog input is then converted into a digital signal and stored on the recording device to be routed to an Internet-enabled display device. The Internet-enabled display device receives the digital signal and accesses the recorded website address and associated website.

### FIELD OF THE INVENTION

The present invention relates to the fields of manual and voice-activated recording, to data conversion and storage, and the interfacing of data to computing devices having access to the Internet.

### BACKGROUND OF THE INVENTION

As the number of regular Internet users increases, a common situation encountered by individuals is becoming aware of entities that possess an online presence, known commonly as a website. Such entities include vendors of business or consumer products or services, as well as nonprofit organizations, governmental bodies, individuals and the like.

Potential customers are often informed of website addresses several times per day. For example, if an individual is listening to the radio or watching television, he or she will hear and/or see numerous advertisements that includes the address of a website relating to the product or service being advertised. Furthermore, website addresses can be found in alternate mediums including, but not limited to magazines, billboards, Internet banner advertisements and even through personal communication.

While an individual can be introduced to a multitude of websites every day from a plurality of media sources, many individuals are unable to remember most, let alone all of the website addresses they can desire to visit when they have the opportunity to utilize an Internet-enabled device. Recording methods exist such as manually writing website addresses on paper, speaking into a microphone and recording an audio message, or entering the address into a portable computing device. However, these conventional methods of recording are often inconvenient. Furthermore, these methods are not specifically designed to record Internet website addresses, with the capability to use the recorded Internet website addresses to directly access desired websites.

Therefore, it is a novel aspect of the present invention to provide a manually or voice-activated handheld device which can record Internet website addresses, convert the analog audio input into a digital format, and use a digital output which is connected to an Internet accessible device to open and/or download the websites corresponding to the recorded website addresses.

Bissonnette et al. U.S. Pat. No. 5,602,963 discloses a voice-activated personal organizer. Bissonnette teaches a hand-held device which comprises a voice-activated microphone, voice recognition and conversion of spoken words into digital format, and digital to analog conversion with analog output via a speaker. Bissonnette's invention can be utilized for a variety of applications where it is desirable to have easy user data storage with voice playback capabilities for future reference. However, Bissonnette does not provide a digital output device for coupling to an external digital device, such as a computer, wherein a signal is sent from a handheld device containing information to trigger one or more functions within the external digital device. Furthermore, Bissonnette does not disclose any other means for a user to record a short message, such as a website address, in a handheld device wherein the message serves as a command to open a specific program or file, such as a website.

Worthington et al. U.S. Pat. No. 5,698,834 discloses a voice-activated, voice recognition portable data collection terminal. The system of Worthington et al. comprises features of common voice recorders and adds voice prompts and voice recognition functions to increase functionality, flexibility, and ease of use. However, the system disclosed in Worthington et al. only utilizes vocal input means for prompting the controller while the recorded data comprises digital keyboard input and/or bar code readers. Therefore, Worthington et al. fails to teach a voice-activated voice recorder adapted for interfacing with a web browser.

Salazar et al. U.S. Pat. No. 5,802,467 discloses a communication and control system for data transmission and reception. Salazar et al. teaches a device for voice-activated voice recording with a display device wherein an output signal is provided in digital format for transmission via radio frequency or infrared frequency to external devices including telephone, paging and intercom systems. However, Salazar et al. does not provide a means for connecting a digital signal to a device to be used for accessing Internet websites using a website address. Dahlke et al. U.S. Pat. No. 6,154,526 discloses a data acquisition and error correcting speech recognition system which is particularly designed for telecommunications. This system provides the user with the automatic prompting and/or correcting of user information if a mistake appears likely. Characteristics of each user, such as most common mistakes, can be stored within the system for increased efficiency. Dalke simply provides for a speech recognition and correction system. However, Dahlke fails to disclose a voice recorder adapted to interface with an Internet web browser by means of using a website address.

In view of the foregoing, clearly there exists a need for a voice-activated recorder which is adapted to interface with an Internet accessible device. Furthermore, there is a need in the art to provide a simple and practical method of accessing websites through the process of recording a vocal signal containing a website address.

### SUMMARY OF THE INVENTION

The present invention comprises a handheld device which functions to record a vocal input signal comprising an analog representation of a website address in common format. The analog input signal is then converted into a digital signal which is coupled to an Internet accessible device, or host. The digital signal instructs the host to open and/or download the website which corresponds to the website address initially recorded as, or entered in the form of the vocal input signal.

The device of the present invention comprises voice recognition software, commonly known in the art, which activates the device upon recognition of a particular vocal signal. Since the device is only activated by a particular, pre-programmed signal, the device consumes limited power and exhibits simplified operation. Upon detection of a vocal input signal, the device will record the signal for a brief time period—enough time for the user to verbally speak a website address. Furthermore, the device implements signal conversion software, contained therein, which converts the recognized analog vocal input signal, a website address, into a digital signal. Furthermore, in one embodiment, the device can then exhibit a playback option. This playback option can include displaying the recorded information on a humanly visible screen of the recording device, audibly replaying the inputted recorded signal or other similar options which are known in the art. In addition, the recording device can be provided with a switch implemented by the recording device to permit any necessary corrections of the website address displayed by the recording device or audibly replayed to the user.

The digital signal produced by the device is then coupled to an Internet accessible device, or host, for direct access to the website related to the website address corresponding to the vocal input signal. The digital output of the device can be coupled to the host by means of a parallel port cable, USB port, PS-2 port, or any other similar type of hardware connection. Furthermore, the digital output of the device can be coupled to the host by any wireless means of transmission known in the art or other similar types of wireless transmission of data, as well as any means developed in the future and not yet contemplated.

A currently available, preferred form of wireless communication is the “Bluetooth” protocol which operates at a frequency of 2.4 gigahertz and has an effective range of approximately 50-100 feet. “Bluetooth” is used for establishing a wireless connection between a personal computer and a printer, however, it can be adapted to serve as communication means between the host and the device of the present invention. Alternatively, infrared and any other suitable form of wireless communication for data transmission can also be used with the present invention.

Additional software can be implemented by the host for receiving the digital data transmitted by the recording device. Furthermore, the software can be installed on the host allowing the device of the present invention to transmit the converted data to the host. For example, the software can enable the recording device to communicate with the host, including, but not limited to the transmitting data instruction to the host to open one or more web browsers on the host and/or download one or more websites onto the host, wherein the one or more website addresses correspond to the digital output of the device. The software package can also include means to selectively display certain websites among those related to the desired addresses, or digital output of the device. Furthermore, additional functions can be incorporated and provided by the software, including for example, book-marking and sorting functions.

Additionally, the device of the present invention can comprise a digital display which can include an LCD (liquid crystal display), an LED (light emitting diode) alphanumeric display, or any other display type currently known in the art, including similar display devices not yet contemplated. Furthermore, one or more buttons and/or switches can be provided which enable the user to make changes to, delete, and/or save the digital signal. A configuration such as this would allow the user to view the vocal input signal after it is converted into digital format and before it is stored within the device or sent to a host. This process allows the user to verify the accuracy of the signal conversion and permits the user to manually make changes to the digital signal. Thus, the user can easily erase, delete and/or re-record over the signal and/or save the signal at any time.

The device of the present invention can also store other types of address information in addition to, or in place of web addresses. For example, the device can store e-mail addresses, medical information, various other information and/or other digital addresses. Furthermore, signal conversion software can be installed on the host in place of being installed on the device, wherein the output signal of the device is not converted to the final digital format until it is connected to, ore received by the host. This embodiment provides a significant power conservation of the device which leads to a longer time of use between charges or battery replacements, as well as lower costs of materials for production of the device and thus, greater affordability and practicality.

Upon connecting the device to the host, the digital output of the device containing the website address is transferred or copied from the recording device to the host. The digital data can be downloaded from the device and immediately deleted from the device afterwards, or can be copied from the device to the host and retained in the memory of both the device and the host until the user chooses to manually delete either item. Furthermore, the device can function as a remote memory device for the host, wherein the digital data can remain in the device's memory while the device is actively accessed by the host. In this manner, the digital data will not be stored on the memory or hard drive space physically located in the host, resulting in reduced data storage or memory requirements of the host.

Another aspect of the present invention comprises the device and/or host that are programmed to serially visit the address of all unviewed websites entered in the device's memory. It is contemplated that the website is deleted automatically after it has been received by the host or is manually deleted by the user at any time.

Therefore, it is an object of the present invention to provide a voice-activated recorder which is adapted to interface with an Internet browser.

It is a further object of the present invention to provide a device which comprises a voice recorder for recording and storing addresses of Internet websites.

It is still a further object of the present invention to provide a device which can be coupled to an Internet accessible device for transferring a data signal.

Furthermore, it is an object of the present invention to provide a device which is handheld and easy to use.

Another object of the present invention is to provide a device which can convert an analog vocal input into a digital output.

It is yet another object of the present invention to provide a device which can display a digital output of a converted analog input.

It is a further object of the present invention to provide a device wherein a digital signal can be manually verified and corrected by the user before it is transmitted to an output.

It is still further and object of the present invention to provide a device wherein a digital signal can be saved, deleted, transferred from, or can be remotely accessed by another device.

Other objects, features and characteristics of the present invention, as well as the methods of operation and functions of the related elements of the invention, and the combination of parts and economies of development and performance, will become more apparent upon consideration of the following detailed description with reference to the accompanying drawings, all of which form a part of this specification.

### BRIEF DESCRIPTION OF THE DRAWINGS

A further understanding of the present invention can be obtained by reference to the preferred embodiment set forth in the illustrations of the accompanying drawings. Although the illustrated embodiment is merely exemplary of systems for carrying out the present invention, both the organization and method of operation of the invention, in general, together with further objectives and advantages thereof, can be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference will be made to the following drawings in which:

FIG. 1 is a pictorial diagram of the preferred embodiment of the voice-activated recorder for interfacing with an Internet browser, according to the present invention, displaying a user implementing the invention while viewing a television:

FIG. 2 is a pictorial diagram of the preferred embodiment, according to the present invention, wherein the recording device is connected to an Internet-enabled display device;

FIG. 3 is a block diagram of the preferred embodiment, according to the present invention, representing the operation of the recording device utilized for recording and interfacing with an Internet browser;

FIG. 4 is a flowchart of the preferred embodiment, according to the present invention, comprising the steps of activating a recording device by verbally activating a voice trigger circuit, recording the data on the recording device and converting the data therein to connect to a display means for viewing a desired website on an Internet-enabled device;

FIG. 5 is a flowchart representing an alternative embodiment of the present invention, comprising the steps of activating a recording device by verbally activating a voice trigger circuit, recording the data on the recording device ore means and transmitting the data to a device for converting the data and accessing a website;

FIG. 6 is a flowchart depicting an alternative embodiment of the voice-activated recorder for interfacing with an Internet browser, according to the present invention, comprising the steps of manually activating the recording device and storing web addresses thereon;

FIG. 7 is a flowchart depicting an alternative embodiment of the voice-activated recorder for interfacing with an Internet browser, according to the present invention, comprising the steps of verbally triggering the activation of the recording device and storing web addresses thereon; and

FIG. 8 is a flowchart depicting an alternative embodiment of the voice-activated recorder for interfacing with an Internet browser, according to the present invention, comprising the steps of interfacing the recording device with a display means for accessing a website.

### DETAILED DESCRIPTION OF THE INVENTION

A detailed illustrative embodiment of the present invention is disclosed herein. However, techniques, systems and operating structures in accordance with the present invention can be embodied in a wide variety of forms and modes, some of which can be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

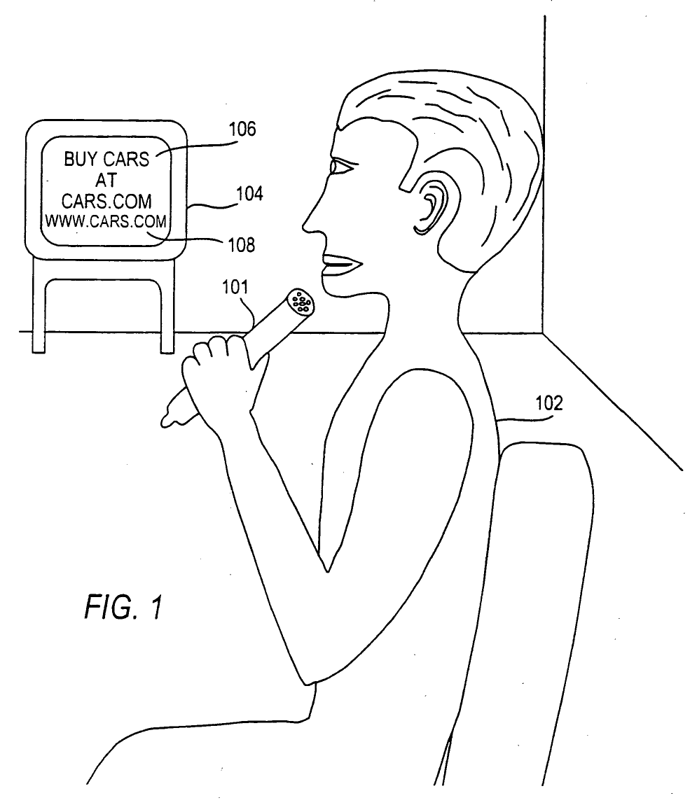

Referring first to FIG. 1, depicted is a diagram of the preferred embodiment of the voice-activated recorder for interfacing with an Internet browser displaying a user 102 implementing the invention while viewing a television screen 104. Upon viewing an advertisement 106 on a television screen 104 or other like device, a user is provided information pertaining to a product, service or the like which includes the display of a website address 108. The website address 108 can allow the user to procure additional information regarding or related to the product or service being advertised. Therefore, if the user 102 desires to access the website pertaining to the product being advertised, the user can activate the recording device and record the website address information thereon.

In the preferred embodiment, the recording device 101 comprises a voice-activated switch means. However, in alternative embodiments it is contemplated that additional means for activating the recording device 101 (e.g., a simple switch mechanism) can be provided. After activating the recording device 101, the user 102 can proceed to verbally provide the website address 108 as displayed on the television screen 104. The spoken website address is then recorded by the recording device 101 and stored in the memory of the recording device 101. Subsequently, the recording device 101 interprets the stored information to be interfaced to a display unit for displaying the desired website.

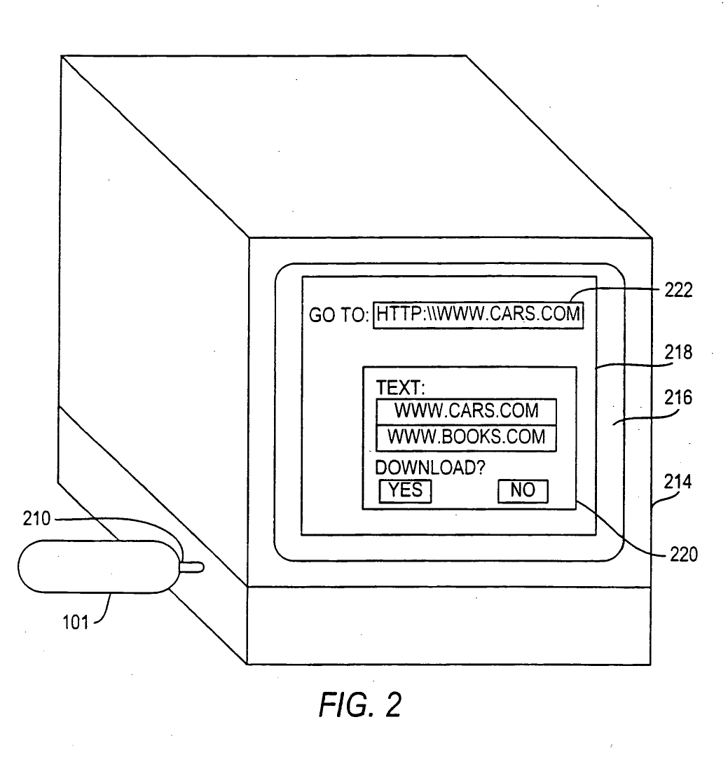

Referring next to FIG. 2, depicted is a diagram of the preferred embodiment of the present invention wherein the recording device 101 is interfaced with an Internet-enabled display device for displaying the desired website of a recorded website address. Recording device 101 comprises a plug 210 or other connecting means for interfacing recording device 101 to a personal computer 214 or other device (e.g., a laptop computer, a personal digital assistant, a cellular telephone, etc.) for connecting to or displaying the desired website. Although plug 210 in the preferred embodiment comprises a plug for connecting to a parallel port or USB port it is well known in the art that a multitude of other types of plugs for connecting to a wireless port, infrared port, or other hardware connection can be utilized for interfacing recording device 101 to a personal computer 214 or device. Upon interfacing recording device 101 to personal computer 214, the internet browser of the personal computer can automatically provide an internet browser window 218 to be automatically displayed on the display unit 216 of the personal computer 214. Furthermore, a program command window 220 can be displayed on the display unit 216 of the personal computer 214 to allow the user to transfer one or a plurality of website addresses to the personal computer 214. Upon transferring the website addresses to the personal computer 214, the personal computer 214 can be programmed to access any of the plurality of websites associated with the recorded website addresses either serially, or in a predetermined sequence. Furthermore, software can be provided which directs the program command window 220 to provide several options to the personal computer user. For example, an address bar can be provided depicting all of the recorded addresses which were transferred to the personal computer 214. In addition, the user can actively select the desired website addresses to access or bookmark specific addresses for future use.

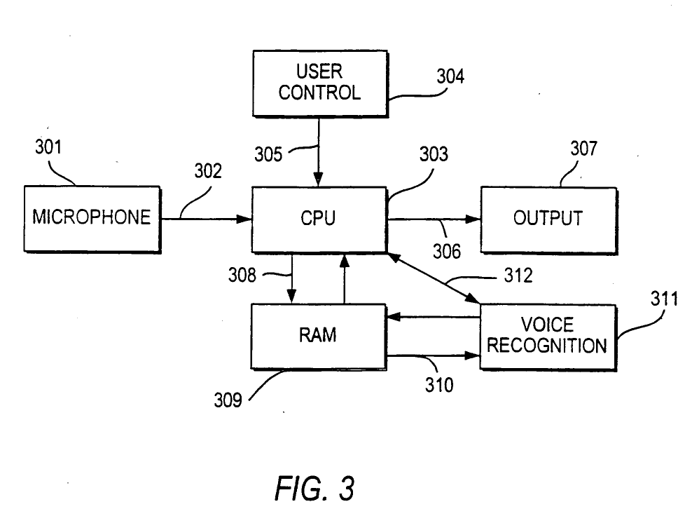

Referring next to FIG. 3, there is shown a block diagram of the preferred embodiment representing the operation of the recording device utilized for recording and interfacing with an Internet browser. Analog voice input of a web address (or other data) is received by microphone 301 and is converted to an electrical signal. The microphone can be of the electromagnetic type, or of the piezo type, or other of microphone technologies known in the art. The electrical signal travels via a unidirectional interface 302 to the central processing unit (CPU) 303. The CPU 303 digitizes and subsequently stores the voice input in random access memory (RAM) 309, which is accessible to the CPU 303 via bidirectional interface 308. Upon instruction by the CPU 303 via bidirectional interface 312, voice recognition means 311 interfaces with RAM 309 to request and receive the stored voice input via interface 310. Thereafter, voice recognition means 311 processes the voice input, under control of CPU 303. The voice recognition means 311 after processing the voice input, outputs digital data representative of the words of the voice input, e.g., “www.website.com”, to a separate region of RAM 309. The CPU 303 thereafter selectively retrieves the digital data from RAM 309 and outputs the digital data via unidirectional interface means 306 to an output 307. The output can be connected to a computer or other device adapted to receive data, and preferably, further comprises a display device disposed within the apparatus itself. User control 304, with a unidirectional interface 305 with CPU 303, allows the user to edit the digital data prior to its final transmittal via output 307. For example, user control 304 can comprise a plurality of buttons or keys that allow letter by letter editing of digital data.

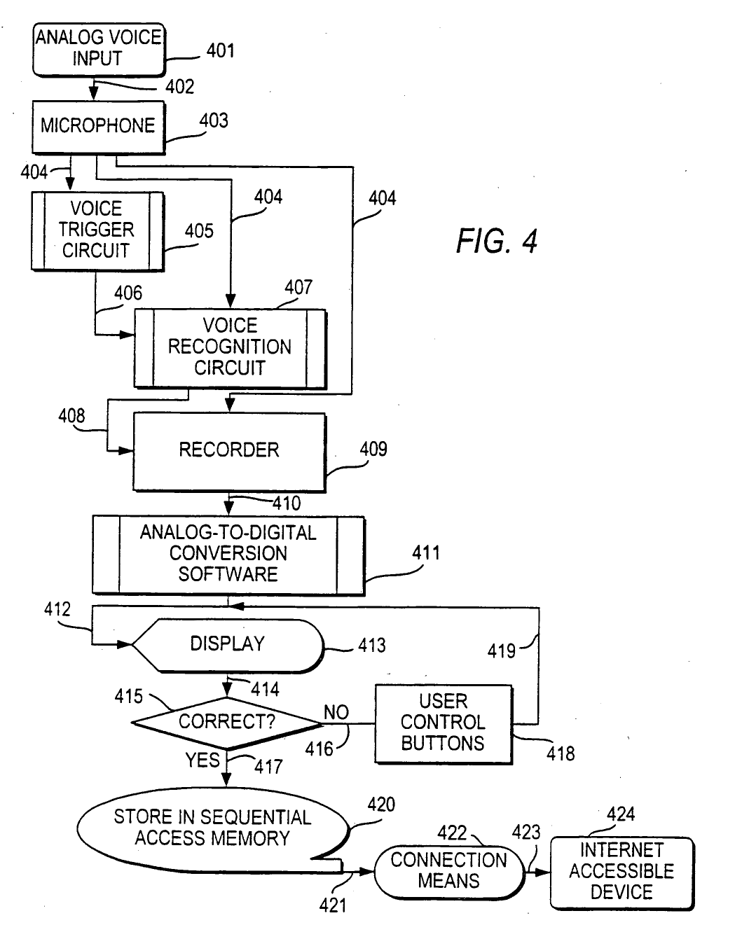

Referring next to FIG. 4, a preferred embodiment of the present invention is depicted. In this embodiment, the device comprises microphone 403, recorder 409, display 413 and user control buttons 418 hardware, as well as voice trigger 405 and voice recognition 407 circuits and sequential access memory 420. Additionally, signal transmission connecting means 422 are provided for connecting the device of the present invention with an Internet accessible device 424.

Microphone 403 receives an analog input 401 at microphone input 402 and sends the signal 404 to voice trigger circuit 405, voice recognition circuit 407 and recorder 409. Upon receiving signal 404, voice trigger circuit 405 is enabled and determines if signal 404 is of an analog voice signal type. Upon determination of an analog voice signal voice trigger circuit 405 sends an enabling signal 406 to voice recognition circuit 407, which then receives signal 404 and determines if signal 404 comprises a particular analog voice (predetermined in setup). Upon determination of a particular analog voice, voice recognition circuit 407 sends an enabling signal 408 to recorder 409. Recorder 409 then activates to record signal 404.

Recorded analog voice signal 410 is sent to analog-to-digital conversion software 411, which converts the analog voice signal 410 into digital signal 412. Digital signal 412 is sent to display 413 which displays digital signal 412 in text format. The user is then able to determine if analog voice input 401 was correctly converted to the desired digital signal 412 by viewing display 413. Display signal 414 enters correction box 415 where the user decides if display signal 414 is correct or must be modified. Correction box 415 can comprise a simple switch accessible by the user.

If display signal 414 is correct and user chooses “Yes” option means 417, the display signal is sent for storage in sequential access memory 420, wherein display signal 414 remains until it is accessed as digital output signals 421 and 423 via connection means 422 by Internet accessible device 424. If display signal 414 is not correct and user selects “No” 416, incorrect signal 416 is sent to a plurality of user control buttons 418, which allow the user to select various options such as delete incorrect signal 416, automatically alter incorrect signal 416 to correct “common errors” (wherein a database of common errors is compared with incorrect signal 416 and corrected upon determination of a common error), or manually alter incorrect signal 416. Manually altering incorrect signal 416 can comprise one or more switches or buttons which are coupled to display 413, which allows the user to sequentially change individual characters on display 413. For example, one button can toggle between each character space. Upon selecting an incorrect character, the user can then click another button that traverses through a list of all other characters, which can be arranged alphabetically or by type such as vowel, consonant, number, or punctuation. When the user reaches the desired character, another button can be provided that is clicked which stores that character in place of the incorrect character and the new digital signal is saved and sent back to display input 412 through corrected signal 419. Further corrections to display signal 414 can be made following the same procedure described as display signal enters correction box 415 once again. Additionally, user control buttons 418 can comprise one or more buttons, wherein one or more buttons perform more than one function. For example, one button can comprise a three-position toggle switch which can traverse up and down, for between character spaces on display 413 and through stored character list. Another button can be a push-button to select the character space or character type shown. In this manner, a user selects the position of the character that is to be replaced with toggle switch, and clicks the push-button switch to select the position. The user then selects a character to insert in the chosen space using the same toggle switch and clicks the push-button switch to select the character. Variations of switch types and switching function configurations can also be applied to achieve the desired result of the previous stated function of user control buttons 418. A variety of other devices for accomplishing the results described above are well-known and available in the art.

Digital output signal 423 is received by Internet accessible device 424 via digital output signal 423 traveling through connecting means 422. Connecting means 422 can comprise hardware connections such as, but not limited to, a parallel port cable, USB port. PS-2 port. Furthermore, connecting means 422 can comprise wireless transmission including, but not limited to, the “Bluetooth” protocol, infrared, or any other future means of wireless transmission. Internet accessible device 424 can be any computer, personal digital assistant (PDA), or television/display unit which is capable of accessing the Internet. Furthermore, in the present invention analog voice input 401 and corresponding digital output signal 423 comprise analog and digital, respectively, representations of a website address, wherein Internet accessible device 424 uses the digital output signal 423 form of the website address to access a website on the Internet.

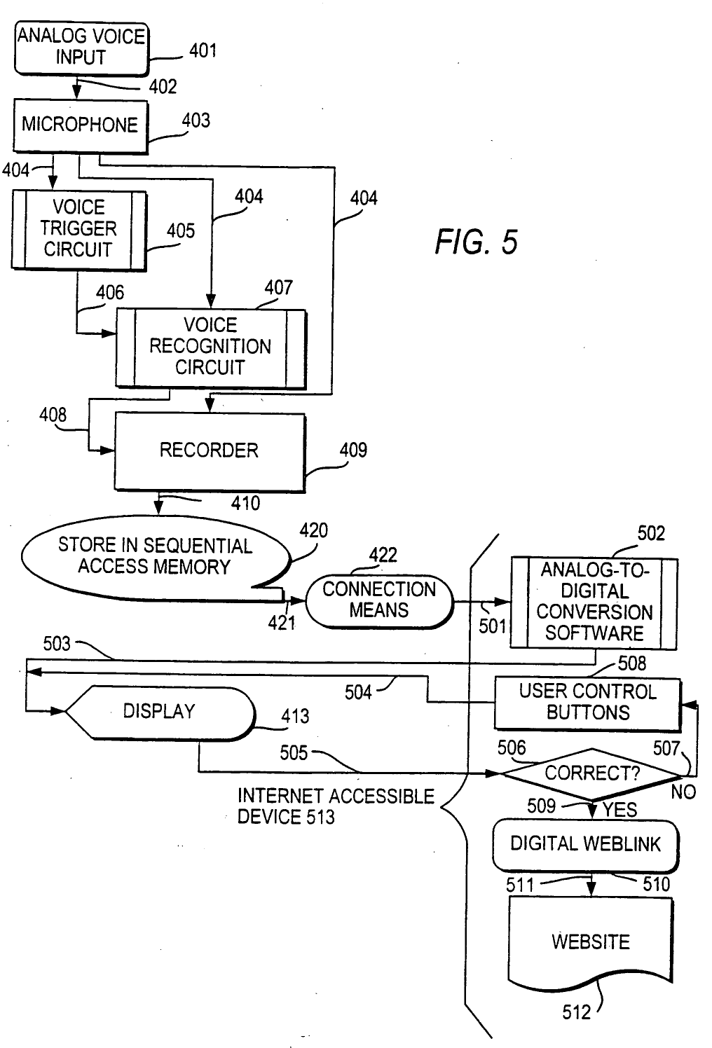

Another embodiment of the present invention is depicted in the flowchart of FIG. 5. As in FIG. 4, the device of the present invention comprises analog voice input 401, microphone 403, voice trigger circuit 405, voice recognition circuit 407, recorder 409, sequential access memory 420, connecting means 422 and display 413. With the exception of the connection of display 413, these components operate as in FIG. 4. In FIG. 5, however, Internet accessible device 513 comprises digital-to-analog conversion software 502, user control buttons 508, correction function 506 and a website 512 corresponding to digital weblink 510.

Internet accessible device 513 receives an analog output signal 501 from connecting means 422 in communication with the recording device of the present invention. Analog output signal 501 is then sent to analog-to-digital conversion software 502 installed on Internet accessible device 513. From there, digital signal 503 is sent to display 413 by connecting means which can be the same as connection means 422.

Upon viewing display 413, the user is given the option of saving digital signal 505 by means of software on Internet accessible device 513. Upon saving digital signal 505, correct digital signal 509 becomes digital website address 511 via digital weblink 510. Digital website address 511 then functions to open a web browser on Internet accessible device 513 with website 512 according to digital website address 511.

If the user decides that digital signal 503 contains errors compared to the intended analog voice input signal 401, the user can change particular characters of incorrect digital signal 507 by means of user control buttons 508 on Internet accessible device. Such changes can be made as described above in connection with FIG. 4. However, it will be understood that the software and controls are located within Internet accessible device. Upon making character changes, corrected digital signal 504 is sent to display 413 (either by the same connecting means 422 or other connecting means). The correction process can be repeated if there are additional changes to be made; otherwise, corrected digital signal 509 is sent to digital weblink 510 and website address 511 opens website 512 on a web browser displayed on Internet accessible device 513.

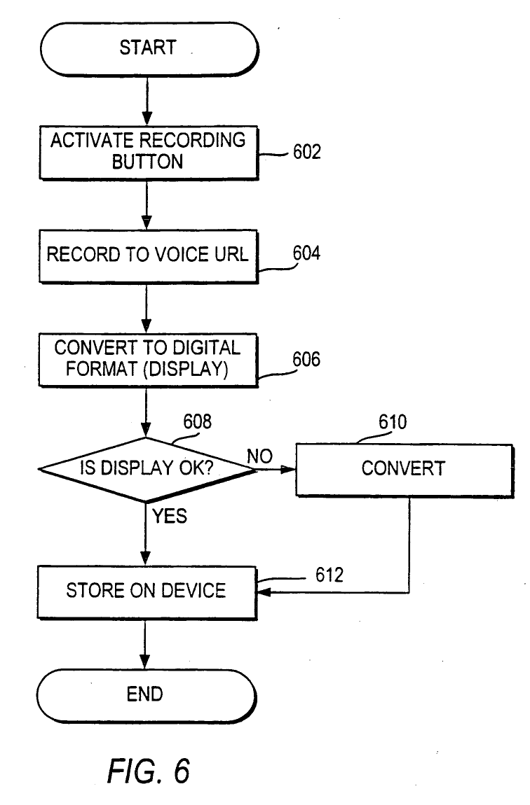

Referring next to FIG. 6, an alternative embodiment of the present invention is described. Storing the desired website address on the recording device begins by activating the recording button 602 on the recording device. The user speaks into the recording device and the information is recorded 604. The recording device converts the data to a digital format 604 for display on the display means of the device. The user is then able to edit the displayed digital data 608. If the display exhibits an error in recording the voice input, the user is provided an opportunity to correct the input 610. Correction of the input can be performed in several ways known in the art, including voice “write-over” and by manually editing the input with a switch-type apparatus. When the displayed digital data is determined to be correct, the data is then stored on the device 612 for use.

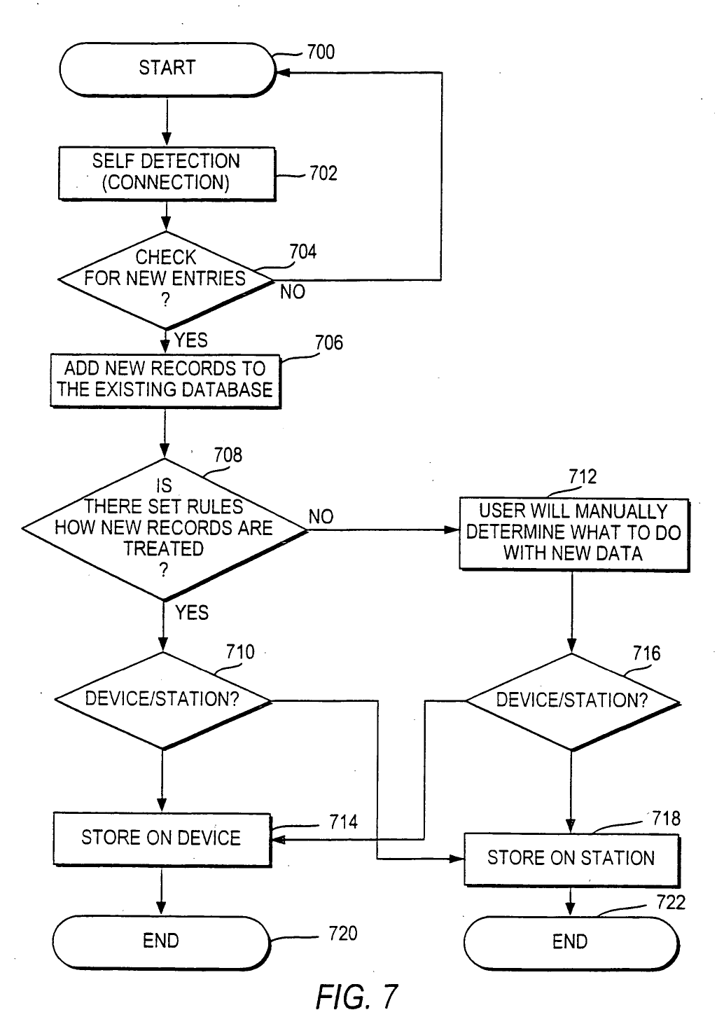

Referring next to FIG. 7, a further preferred embodiment of the invention is provided. A user commences the process 700 by speaking into the recording device. Connection with the recording device is established upon recognition of the voice input 702. The recording device verifies if the voice input is a website address 704 of the type desired by the user or undesired “background noise”. If the voice input is a website address, the recording device adds the voice input to the database 706. Furthermore, the user can selectively program the recording device 708 to automatically store in a specific way, bookmark or edit the input for the proper treatment of the website address. If a set of rules are programmed into the device, the recording device can provide the option of storing the voice input on the recording device or routing the voice data to an alternate station (e.g., personal computer) for storing the data 710. Depending on the desired selection, the data is subsequently stored on the recording device 714 or stored on the alternate station 718. However, if a set of rules does not exist, the user can manually edit the stored voice input 712. Subsequently, the recording device provides the option of storing the voice input on the recording device or routing the voice data to an alternate station (e.g., personal computer) for storing the data 710. Depending on the desired selection, the data is subsequently stored on the recording device 714 or stored on the alternate station 718.

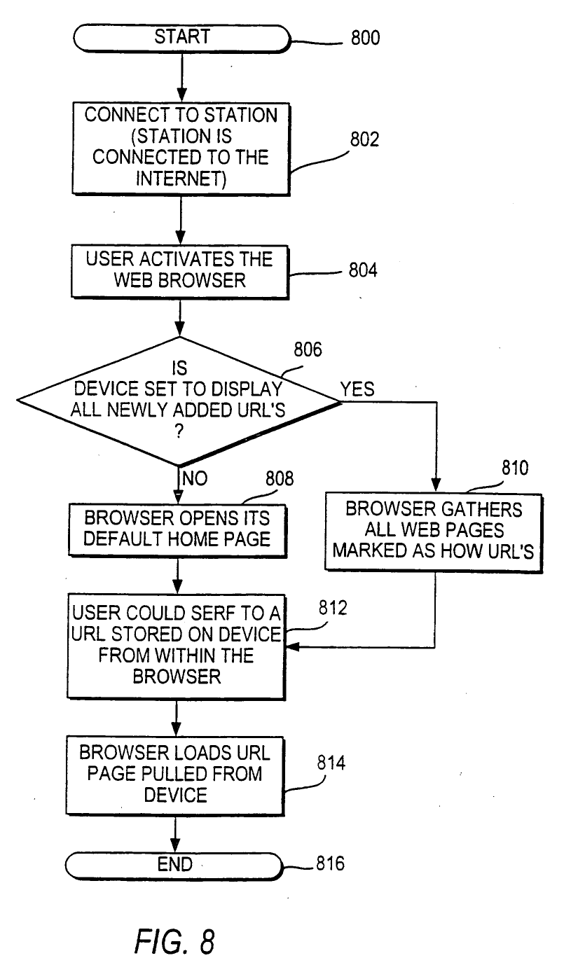

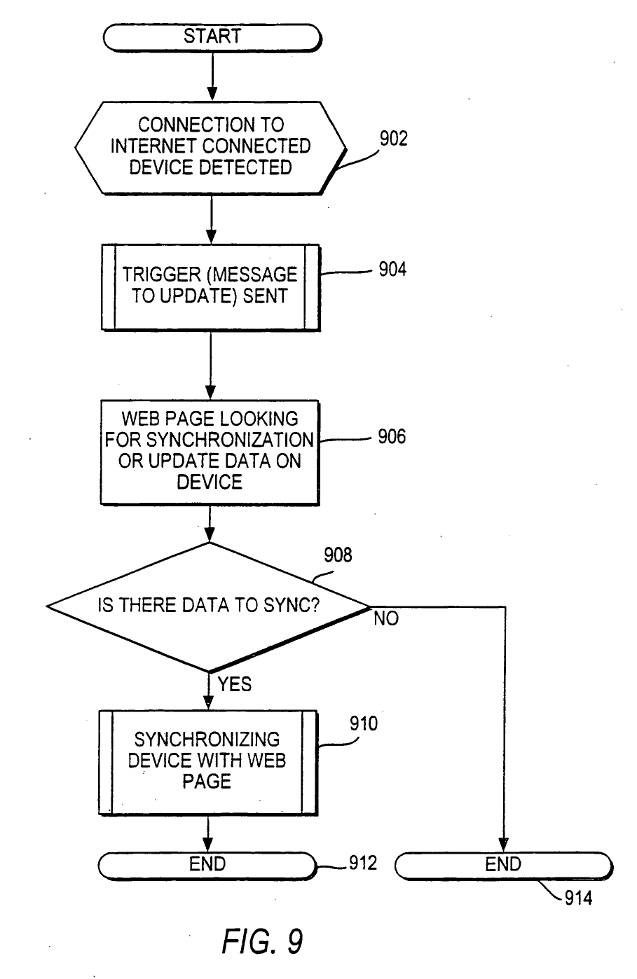

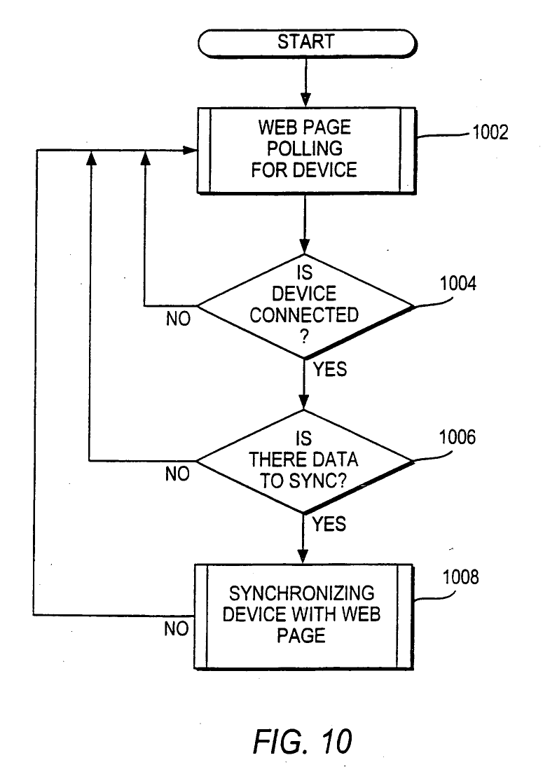

Referring next to FIG. 8, there is shown a flowchart of a further embodiment of the voice-activated recorder for interfacing with an Internet browser, according to the present invention, comprising the steps of interfacing the recording device to a display means for accessing a website. The recording device is interfaced with an Internet-enabled device (e.g., work station) 802. The user activates the Internet browser 804. If the recording device is pre-programmed to direct the Internet-enable device to access the recorded website addresses 806 of the recording device, the browser automatically gathers the website addresses for display to the user 810. Alternatively, if the recording device is not pre-programmed to access the recorded website addresses, the Internet-enabled device reverts to a default web browser 808. The user is then able to selectively access the desired website addresses which were recorded on the recording device 812. Based on the user interactions, the Internet-enabled device receives the data from the recording device and instructs the web browser to load the desired website address to access the desired website 814.

While the present invention has been described with reference to several preferred embodiments, which embodiments have been set forth in considerable detail for the purposes of making a complete disclosure of the invention, such embodiments are merely exemplary and are not intended to be limiting or represent an exhaustive enumeration of all aspects of the invention. Further, it will be apparent to those of skill in the art that numerous changes can be made in such details without departing from the spirit and the principles of the invention. The scope of the invention, therefore, shall be defined solely by the following claims.

1-35. (canceled)

36. A handheld device comprising:
voice recording means for recording a first signal, said first signal being analog and representative of one or more spoken addresses accessible via the Internet;
voice recognition means for recognizing said one or more spoken addresses in said first signal and generating a second signal in accordance with the voice recognition, wherein said second signal is digital and representative of at least one command to be executed by a separate Internet accessible device to perform an access operation to one of said one or more spoken addresses as recognized;
output means for outputting said second signal; and
coupling means for interfacing said output means with the Internet accessible device;
whereby said device, via said coupling means, instructs the Internet accessible device to perform an access operation to one of said one or more spoken addresses.

37. A device in accordance with claim 36, wherein said one or more spoken addresses include e-mail addresses.

38. A device in accordance with claim 36, wherein said one or more spoken addresses include website addresses.

39. A device in accordance with claim 36, wherein said voice recording means comprises voice triggering means such that said voice recording means is enabled upon detecting a voice signal.

40. A device in accordance with claim 36, comprising voice triggering means such that said recording means is enabled upon detecting a voice signal, said voice triggering means further coupled with voice recognition means, said voice recognition means being enabled after said voice triggering means is enabled, and further enabling said voice recording means upon recognizing unique voice signals.

41. A device in accordance with claim 36, wherein said access operation includes opening one or more web browsers containing a website corresponding to said one or more spoken addresses.

42. A device in accordance with claim 36, wherein said access operation includes downloading one or more websites corresponding to said one or more spoken addresses.

43. A device in accordance with claim 36, wherein said access operation includes displaying certain websites corresponding to said one or more spoken addresses.

44. A device in accordance with claim 36, wherein said access operation includes serially visiting one or more websites corresponding to said one or more spoken addresses and storing said one or more websites in a memory of said Internet accessible device for future viewing on said Internet accessible device.

45. A device in accordance with claim 36, wherein the corresponding websites of said one or more spoken addresses are stored on said Internet accessible device and are deleted automatically after being accessed.

46. A device in accordance with claim 36, wherein the corresponding websites of said one or more spoken addresses are stored on said Internet accessible device until they are manually deleted.

47. A device in accordance with claim 36, wherein said Internet accessible device comprises website bookmarking means.

48. A device in accordance with claim 36, wherein said Internet accessible device comprises website sorting means.

49. A device in accordance with claim 36, wherein said device further comprises a display.

50. A device in accordance with claim 49, wherein said display is a liquid crystal display.

51. A device in accordance with claim 49, wherein said display comprises a light emitting diode display.

52. A device in accordance with claim 36, wherein said coupling means comprise universal serial bus means.

53. A device in accordance with claim 36, wherein said coupling means comprise a parallel interface.

54. A device in accordance with claim 36, wherein said coupling means comprise a PS-2 port connection.

55. A device in accordance with claim 36, wherein said coupling means comprise wireless communication means.

56. A device in accordance with claim 55, wherein said wireless communication means utilizes the 2.4 GHz spectrum.

57. A device in accordance with claim 36, wherein said coupling means comprise wireless transmission means utilizing infrared signals.

58. A device in accordance with claim 36, wherein said device further comprises one or more control buttons.

59. A device in accordance with claim 36, wherein said device further comprises one or more control buttons, said buttons further comprising a data change function.

60. A device in accordance with claim 36, wherein said device further comprises one or more control buttons, said buttons further comprising a delete function.

61. A device in accordance with claim 36, wherein said device further comprises one or more control buttons, said buttons further comprising a save function.

62. A device in accordance with claim 36, wherein said one or more spoken addresses include medical information.

63. A device in accordance with claim 36, wherein said second signal is copied from said device to said Internet accessible device and said second signal is stored in memory of both said device and said Internet accessible device.

64. A device in accordance with claim 36, wherein said second signal is transferred from said device to said Internet accessible device and wherein said second signal is stored in the memory of said Internet accessible device and is deleted from memory of said device.

65. A device in accordance with claim 36, wherein said second signal is converted to a second analog signal.

66. A device in accordance with claim 65, wherein said Internet accessible device comprises signal conversion means, said signal conversion means converting said second analog signal to a second digital signal.

67. A device in accordance with claim 66, wherein said second digital signal comprises one or more website addresses.

68. A device comprising:
voice recording means for recording an analog input signal, wherein said analog input signal is representative of one or more spoken addresses;
signal conversion means, wherein said analog input signal is converted to a digital signal, said digital signal representative of said one or more spoken addresses;
Internet connection means, wherein said device is connected to the Internet; and
web browser means, receiving said digital signal from said signal conversion means, wherein one or more websites corresponding to said one or more spoken addresses is accessed and displayed.

69. The device of claim 68, wherein the voice recording means is handheld.

70. A method of entering a URL, comprising the steps of:
speaking and simultaneously recording a spoken URL accessible via the Internet using a handheld device, thereby generating a recording;
digitizing said recording to form a digitized signal;
performing a speech recognition algorithm upon said digitized signal;
verifying if the digitized signal is representative of a website address of the URL;
if the digitized signal is verified to be representative of the website address of the URL, extracting a text of said spoken URL; and
outputting said text to a separate Internet device to cause the Internet device to perform an access operation to the URL and to subsequently display the URL.
